(19) United States
(12) Patent Application Publication
(10) Pub. No.: US 2024/0174561 A1
(43) Pub. Date: May 30, 2024

(54) GLASS SUBSTRATE AND METHODS OF MAKING THE SAME

(71) Applicant: CORNING INCORPORATED, Corning, NY (US)

(72) Inventors: Robert Randall Hancock, JR., Corning, NY (US); En Hong, Painted Post, NY (US); Ming-Huang Huang, Ithaca, NY (US); Aize Li, Painted Post, NY (US)

(21) Appl. No.: 18/383,547

(22) Filed: Oct. 25, 2023

Related U.S. Application Data
(60) Provisional application No. 63/428,476, filed on Nov. 29, 2022.

(51) Int. Cl. C03C 23/00; C03C 3/085; C03C 3/093; C11D 7/02

(52) U.S. Cl. CPC C03C 23/0075; C03C 3/085; C03C 3/093; C11D 7/02

(57) ABSTRACT

Various aspects of the present disclosure relate to a method of cleaning a glass substrate. The method includes contacting the glass substrate with a cleaning agent for a predetermined amount of time. The cleaning agent includes a substance having a sublimation point in a range of from about −90° C. to about −70° C. and the cleaning agent is dispersed in a gas carrier.

This application claims the benefit of priority under 35 U.S.C. § 119 of U.S. Provisional Application Ser. No. 63/428,476 filed on Nov. 29, 2022, the content of which is relied upon and incorporated herein by reference in its entirety.

### BACKGROUND

Various glass preparation processes (cutting, grinding, polishing, etc.) create glass particles on the edge of the glass, which can then migrate to the glass surface, causing significant problems when films are deposited on display glasses. In addition to improving grinding processes to generate fewer particles, a cleaning process to remove edge particles while retaining glass strength is desired to address this issue.

### SUMMARY OF THE INVENTION

Various aspects of the present disclosure relate to a method of cleaning a glass. The method includes contacting a glass substrate with a cleaning agent for a predetermined amount of time. The cleaning agent includes a substance having a sublimation point in a range of from about −90° C. to about −70° C. and the cleaning agent is dispersed in a gas carrier.

### BRIEF DESCRIPTION OF THE FIGURES

The drawings illustrate generally, by way of example, but not by way of limitation, various aspects of the present invention.

FIG. 1 shows a series of optical images of laser cut glass edge of control sample (top) and dry ice cleaned sample (bottom). Measurements were taken at 10 mm, 25 mm and 40 mm from the left corner of each sample. (Image size is 258.48×193.86 um).

FIG. 2 shows a series of processed confocal images of control (top) and cleaned (bottom) laser cut glass using ImageJ software package. Measurements were taken at 10 mm, 25 mm and 40 mm from the left edge of each sample.

FIG. 3 is graph showing Direct Edge Inspection (DEI) results of control glass compared to samples cleaned with dry ice, showing a significant decrease in the percent area covered by glass particles. Process conditions had little impact on DEI measurement result at same resolution.

FIG. 4 is a graph showing DEI results of control glass compared to samples cleaned with dry ice, showing a significant decrease in the percent area covered by glass particles. Process conditions had little impact on DEI measurement result.

FIG. 5 is a graph showing DEI results of control glass compared to samples cleaned with dry ice, showing a significant decrease in the percent area covered by glass particles. Increasing the sample/nozzle distance had a negative impact on glass cleanliness.

FIG. 6 is a graph showing DEI results of control glass compared to dry ice and wet chemistry cleaned samples, showing a significant decrease in the percent area covered by glass particles with little difference between the 3 methods.

FIG. 7A shows a Weibull plot (top) and FIG. 7B shows a peak stress (bottom) of dry ice and wet chemistry cleaned glass samples determined by vertical 4 point bend test, showing a reduction in edge strength for the wet chemistry cleaned samples (red squares) compared to the dry ice cleaned samples (black circles).

FIG. 8 shows results of a surface morphology analysis on dry ice-cleaned surface vs. control.

FIG. 9 shows results of a 2-sample t-test on flaw depth distribution on dry ice-cleaned edge versus non-cleaned disks.

### DETAILED DESCRIPTION OF THE INVENTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range. Any value or number disclosed herein as modified by the term “about” is also intended to disclose the exact value (the value or number not modified by the term “about”).

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

In general, current glass cleaning methods require techniques to clean glass particles from the glass edges or surface created during glass processing steps. For example, various glass preparation processes (cutting, grinding, polishing, etc.) produce glass particles on the edge of the glass, which can then migrate to the glass surface, causing significant problems when glass is further processed, for example when films are deposited on display glasses.

Typical cleaning techniques are wet cleaning methods that employ cleaning solutions. The cleaning solutions are often organic solvents, or aqueous solutions of detergent, alkali or acid, all of which need to be handled carefully during use and must be disposed in a controlled manner after use. In contrast to wet cleaning methods, the cleaning methods of the instant disclosure represent a non-abrasive and non-toxic dry-cleaning method which does not require a liquid solvent, eliminating the need to dispose of any waste solutions after use. The dry-cleaning methods of the instant disclosure also reduce the generation of flaws due to the contact between glasses and fixtures during the cleaning methods, increasing retained edge strength of the cleaned glasses.

More specifically, in this disclosure a liquid solvent free and non-abrasive cleaning process is described as a method to clean glass edge surfaces, while improving retained edge strength. As an example, this process uses high speed gas (compressed air or compressed nitrogen) to deliver a stream of dry ice (solid carbon dioxide) particles toward a glass substrate to remove particles/debris from the glass surface. By quickly freezing the fine glass particles on glass edges, it allows the glass particles to be easily removed from a glass surface with the aid of high-speed dry ice impaction and sublimation of dry ice. As demonstrated in the examples herein, better than 80% cleaning efficiency has been achieved from a single treatment, which is comparable with wet cleaning experimental results. Additionally, as a dry cleaning technology, when a stream of dry ice blasts across a glass surface, it quickly freezes the surface. The associated shrinkage of the glass surface generates light compression that helps to close surface flaws to some degree and reduces flaw. The examples herein show that the instant method improves surface strength by 17% compared to a traditional wet cleaning approach. As a result, dry ice cleaning technology improves surface strength while removing surface particles and does not generate secondary chemical wastes.

The method according to the disclosure includes the step of contacting a glass substrate with a cleaning agent for a predetermined amount of time. Examples of such glass substrates include a borosilicate glass. An example of a suitable borosilicate glass is a glass that includes from about 50 mol % to about 70 mol % SiO₂; about 5 mol % to about 15 mol % Al₂O₃; about 0 mol % to about 19 mol % B₂O₃ (such as about 5 mol % to about 19 mol % B₂O₃); about 3 mol % to about 10 mol % CaO; about 0 mol % to about 7 mol % K₂O; about 1 mol % to about 10 mol % MgO, about 0.5 mol % to about 5 mol % SrO; and about 0.01 mol % to about 1 mol % SnO₂. An example of a preferred borosilicate glass is a glass that includes from about 60 mol % to about 65 mol % SiO₂; about 7 mol % to about 11 mol % Al₂O₃; about 9 mol % to about 17 mol % B₂O₃; about 5 mol % to about 9 mol % CaO; about 0 mol % to about 3 mol % K₂O; about 2 mol % to about 7 mol % MgO, about 1 mol % to about 3.5 mol % SrO; and about 0.06 mol % to about 0.08 mol % SnO₂.

The glass substrates can be strengthened using any suitable method known in the art, including by including compressive stress (CS) into the glass substrate, that extends from a surface to a depth of compression (DOC). The glass substrates may be thermally strengthened by utilizing a mismatch of the coefficient of thermal expansion between portions of the glass substrate to create a compressive stress region and a central region exhibiting a tensile stress, such as by heating the glass substrate to a temperature above the glass transition point and then rapidly quenching. The glass substrates may also be chemically strengthened, such as by ion exchange, where ions at or near the surface of the glass substrate are replaced by, or exchanged with, larger ions having the same valence or oxidation state.

The thickness of the glass substrates can be tailored to allow the glass substrate to be more flexible to achieve a desired radius of curvature. The thickness of the glass substrate can be substantially constant along its length. The glass substrate can have any suitable thickness, such as about 0.2 mm to about 3 mm (e.g., about 0.2 mm to about 2 mm and about 0.4 mm to about 1.1 mm). Further, the glass substrate, once incorporated into an article can have any suitable bending radius, or radius of curvature. The radius of curvature can be, for example, about 20 mm or greater, 40 mm or greater, 50 mm or greater, 60 mm or greater, 100 mm or greater, 250 mm or greater or 500 mm or greater. For example, the radius of curvature can be in a range from about 60 mm to about 1200 mm. Further still, the glass substrate can have any suitable width, e.g., in a range from about 5 cm to about 250 cm; and any suitable length, e.g., in a range from about 5 cm to about 250 cm.

The cleaning agent can be contacted over the entirety of the surface area of the glass substrate. Alternatively, the cleaning agent can be confined to contact only a certain region of the glass substrate. For example, the cleaning agent can be limited to contact the edge or edge region of the glass substrate. It may be desirable to limit the cleaning to the edges in some examples. This can be because the balance of the glass surface may be held to a higher standard of cleanliness to meet certain optical standards (e.g., transparency) that may require a different cleaning procedure. However, in general, the optical standard required at the edges is less stringent. Therefore, if the disclosed cleaning methods do not result in the balance of the glass surface meeting a certain optical standard, different cleaning methods can be used. The edges of the glass substrate can be sufficiently cleaned using the disclosed methods.

As described herein above, an example of a suitable cleaning agent is dry ice. In general, a suitable cleaning agent will be a substance having a sublimation point in a range of from about −90° C. to about −70° C., about −80° C. to about −70° C., less than, equal to, or greater than about −90° C., −89, −88, −87, −86, −85, −84, −83, −82, −81, −80, −79, −78, −77, −76, −75, −74, −73, −72, −71, or about −70° C. Depending on various factors including the pressure, the cleaning agent can be liquid or solid form. The particles of the cleaning agent, such as when in solid form, can individually have a particle size in a range of from about 100 μm to about 1 mm in diameter, about 1 μm to about 100 μm in diameter, less than, equal to, or greater than about 100 μm, 50 μm, 1 μm, 0.5 mm, or 1 mm.

The cleaning agent is dispersed in a gas carrier. The gas carrier is a compressed gas. The compressed gas can be atmospheric air or nitrogen (N₂) gas. The pressure of the gas carrier can be in a range of from about 1 Bar to about 7 Bar, about 1.25 Bar to about 5.5 Bar, less than, equal to, or greater than about 1 Bar, 1.25, 1.50, 1.75, 2, 2.25, 2.50, 2.75, 3, 3.25, 3.50, 3.75, 4, 4.25, 4.50, 4.75, 5, 5.25, 5.50, 5.75, 6, 6.25, 6.50, 6.75, or about 7 Bar.

In operation, the cleaning agent is dispensed to contact the glass substrate from a dispensing apparatus. An example of a suitable dispensing apparatus is a nozzle. The rate at which the cleaning agent is dispensed can be in a range of from about 0.10 kg/min to about 0.70 kg/min, 0.15 kg/min to about 0.50 kg/min, less than, equal to, or greater than about 0.10 kg/min, 0.15, 0.20, 0.25, 0.30, 0.35, 0.40, 0.45, 0.50, 0.55, 0.60, 0.65, or about 0.70 kg/min. The rate at which the cleaning agent is dispensed can be constant or the rate can vary during the dispensing.

The distance from a distal end of the dispensing apparatus to the glass substrate can be in a range of from about 12.7 mm to about 152.4 mm, about 25.4 mm to about 76.2 mm away from the glass substrate, less than, equal to, or greater than 12 mm away from the glass substrate, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 153, or about 153 mm away from the glass substrate. The distance can be fixed during the dispensing. Alternatively, the distance can be varied throughout the dispensing by moving the nozzle or by moving the glass substrate relative to the nozzle.

Relative to each other, the glass substrate and dispensing apparatus can move at a rate in a range of from about 3 mm/sec to about 10 mm/sec, about 5 mm/sec to about 8 mm/sec, less than, equal to, or greater than about 3 mm/sec, 3.5, 4, 4.5, 5, 5.5, 6, 6.5, 7, 7.5, 8, 8.5, 9, 9.5, or about 10 mm/sec. The rate can be constant or variable. Typically, the glass substrate is passed by the dispensing apparatus, which is fixed. The glass substrate can be moved by a conveyor belt or similar apparatus.

The above described parameters together result in the desired cleaning properties of the glass substrate. The cleaning performance is due to the combination of the sublimation point of the cleaning agent, the pressure of the gas carrier, the rate of dispensing, and the distance between the dispensing apparatus and the glass substrate. The sublimation point of the cleaning agent being within the described range means that the cleaning agent will be cold enough to help strengthen the glass substrate. Specifically, the cold will force the surface of the glass to constrict to some degree which closes gaps, cracks, flaws, and the like in the glass substrate. The pressure of the gas carrier influences the state of cleaning agent, that is whether it is in liquid, solid, or gas form. The liquid or sold form of the cleaning agent allows for the presence of particles or droplets that have some mass that can impact debris on the glass surface and cause the debris to be removed. The rate at which the cleaning agent is dispensed as well as the distance between the dispensing apparatus and the glass substrate are relevant to the force that the particles and/or droplets of the cleaning agent impact the glass substrate with. If the force is not sufficient, then it is less likely that the debris will be dislodged from the glass substrate. Surprisingly and unexpectedly, it was found that conducting the cleaning process outside of these parameters resulted in ineffective cleaning, a lack of strengthening the glass substrate, or both.

### EXAMPLES

Various aspects of the present invention can be better understood by reference to the following Examples which are offered by way of illustration. The present invention is not limited to the Examples given herein.

Glass substrates were tested to evaluate the effectiveness of the disclosed cleaning methods. The glass substrates subjected to testing were formed from glass compositions including 70.41 mol % SiO₂, 13.31 mol % Al₂O₃, 1.78 mol % B₂O₃, 4.07 mol % MgO, 5.34 mol % CaO, 1.22 mol % SrO, 3.78 mol % BaO, and 0.09 mol % SnO₂.

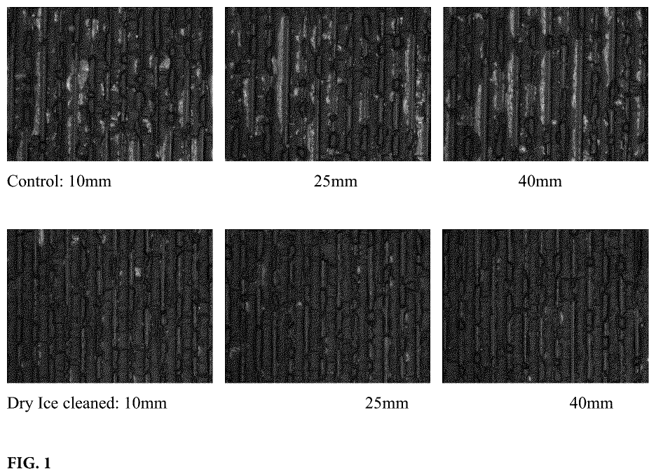

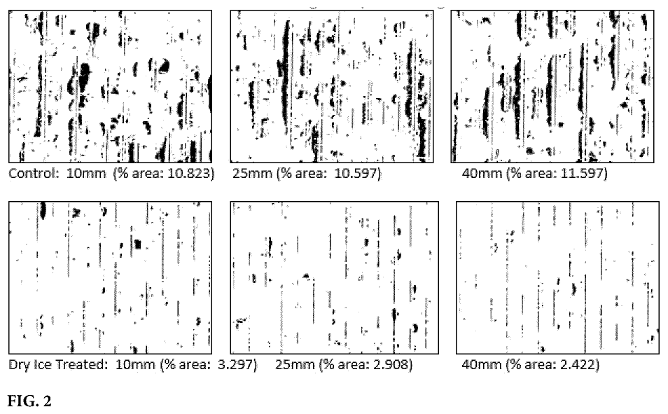

Direct Edge Inspection (DEI) analysis by confocal microscopy was used to evaluate the cleanliness of glass edges. Three confocal images were taken of each glass substrate sample (2″×2″ coupon) at three locations: 10 mm, 25 mm and 40 mm from the left corner of each sample with the measurement conditions as reported in Table 1. Optical images of both control and cleaned glass substrate samples were obtained and are shown in FIG. 1. The obtained optical images were imported into the ImageJ software analysis package to process the image for the total contamination area analysis. The analyzed images are shown in FIG. 2. After analysis, the percentage of the area above the background threshold, shown in black in FIG. 2, is used to evaluate glass cleanliness (a lower % area covered indicates a cleaner surface).

TABLE 1
Confocal set-up for DEI measurements of glass edges.

| Confocal Setup | Confocal Condition |
|---|---|
| Magnification | 50× |
| Z stack image | −10 to 10 μm, 0.5 μm increments |
| Exposure | 33 ms |
| Gain | 1.70× |

### Example 1

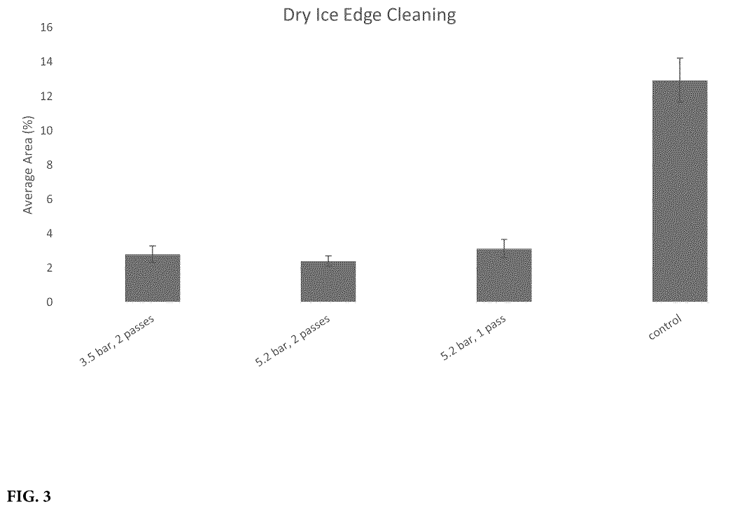

Glass cleaning procedures were tested on 2″×2″ laser cut glass substrates (5 pieces per condition) with a travel rate of 6 mm/sec through the cleaning agent stream. The cleaning agent was dry ice (solid CO₂). The dry ice feed rate was held constant at 0.45 kg/min and the nozzle distance was constant at 2 inches from the glass substrate sample. Compressed N₂ was utilized as the carrier gas and the carrier gas pressure was varied between 3.5 and 5.2 Bar. The samples were exposed to 1 pass or 2 passes through the cleaning agent stream. DEI results of control glass samples compared to samples cleaned with the dry ice containing cleaning agent stream showed a significant decrease in the percent area covered by glass particles as shown in FIG. 3. The various process conditions tested had little impact on the DEI measurement results.

### Example 2

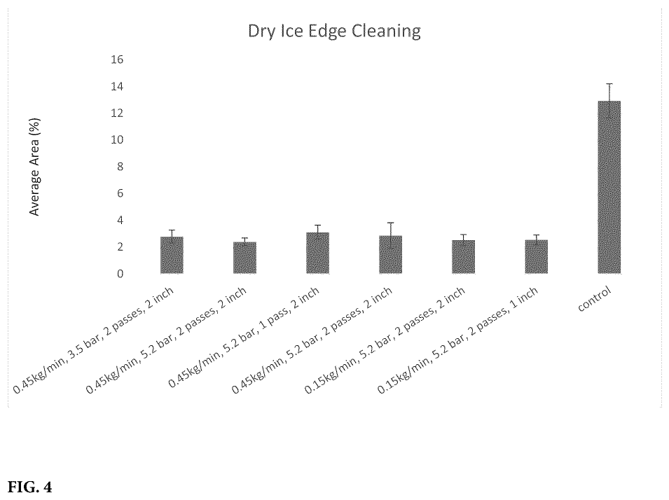

Glass cleaning procedures were tested on 2″×2″ laser cut glass substrates (5 pieces per condition) with a travel rate of 6 mm/sec through the cleaning agent stream. The cleaning agent was dry ice in compressed N₂ at 5.2 bar. The dry ice feed rate was varied between 0.15 kg/min and 0.45 kg/min and the nozzle/sample distance was varied between 1 and 2 inches. DEI results of control glass substrates compared to samples cleaned with dry ice showed a significant decrease in the percent area covered by glass particles as shown in FIG. 4. The various process conditions tested had little impact on DEI measurement result at same resolution.

### Example 3

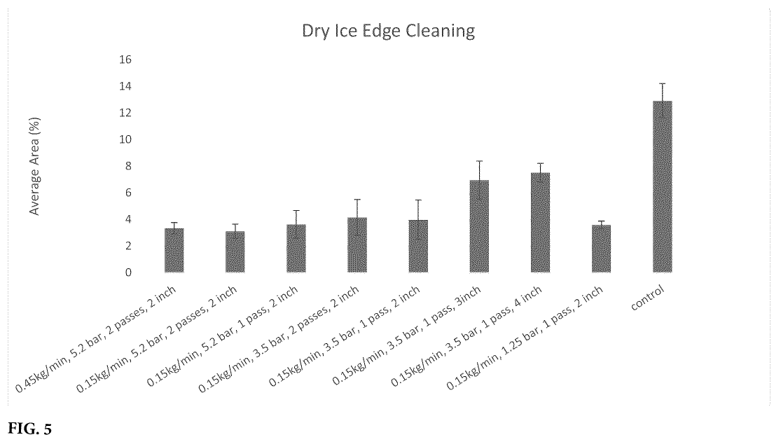

To find the most efficient way to clean the glass substrate edge, different cleaning conditions were tested. The varied testing conditions included: dry ice feeding rate, applied air pressure, nozzle/substrate distance, and total time of treatment. 2″×2″ laser cut glass substrates (5 pieces per condition) were used in the test with a travel speed of 6 mm/sec and 1-2 cycles of cleaning treatment. DEI results showed similar cleaning result for all conditions with a 2 inch working distance as shown in FIG. 5. The 2 inch working distance produced slightly better performance than 3 inch and 4 inch working distance conditions. It was determined that at a dry ice feed rate of 0.15 kg/min, N₂ pressure of 1.25 Bar, with 1 pass and a sample/nozzle distance of 2 inches the optimum efficiency.

### Example 4

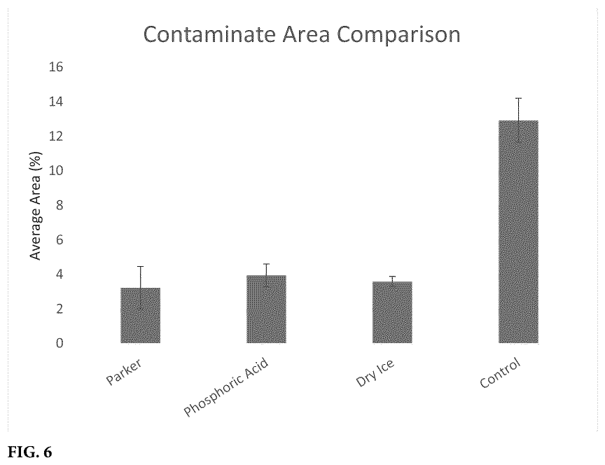

In order to compare cleanliness and edge strength of the dry ice cleaned glass substrate samples with wet chemistry cleaned samples, laser cut glass substrates (2″×2″) were cleaned under the dry ice cleaning conditions as shown in Table 2. Additionally, 2 sets of samples were cleaned separately in a 4 wt % Parker (detergent) solution and an acidic solution (PNA) of 80% phosphoric acid, 5% nitric acid, and 5% acetic acid at 65° C. under ultrasonication for 20 minutes as reported in Table 2. DEI measurements indicated comparable cleaning results between the dry ice method and the 2 wet chemistry methods as shown in FIG. 6.

TABLE 2
Cleaning conditions used to compare dry
ice cleaning with wet chemistry cleaning.

| Cleaning method | Cleaning Condition |
|---|---|
| Dry Ice | 0.15 kg/min feed rate, 1.25 bar N₂ pressure, 1 |
| | pass, 2-inch nozzle/sample distance |
| Detergent cleaning | 4 wt % Parker detergent, 65° C., 20 min with |
| (Parker) | sonication |
| Detergent cleaning | (PNA) 80% phosphoric acid, 5% HNO₃, 5% |
| (Phosphoric acid) | acetic acid, 65° C., 20 min with sonication |

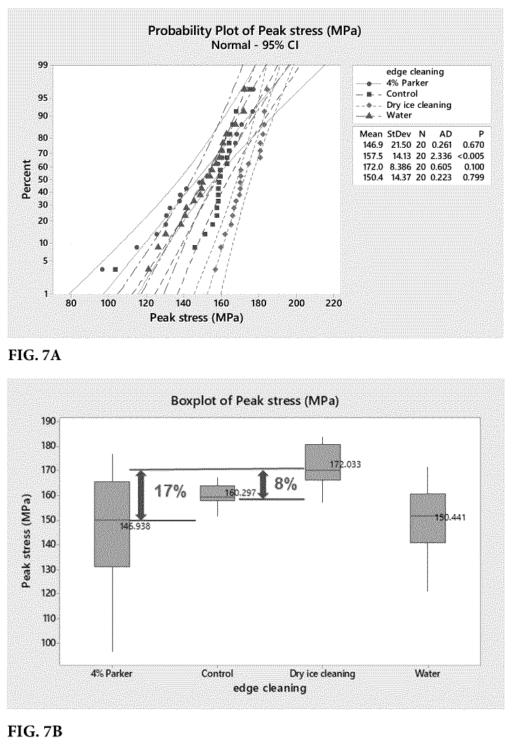

To compare edge strength, a series of 11 mm×150 mm laser cut glass substrate samples were cleaned and subsequently tested with a four point bend test. The dry ice cleaning condition of Table 2 was used again and compared to the Parker detergent wet chemistry procedure. The results of the four point bend test for the dry ice cleaned samples, the wet chemistry cleaned samples, the water cleaned samples, and the control samples (non-cleaned) are shown in Table 3. FIG. 7 is a Weibull plot analysis that shows that the glasses cleaned by dry ice not only show improved edge strength, but also a narrow peak stress distribution compared to non-cleaned and wet chemistry cleaned counterparts.

TABLE 3
Cleaning conditions used to compare edge strength
of dry ice cleaning with wet chemistry cleaning.

| | | Mean | Peak | | | | |
|---|---|---|---|---|---|---|---|
| | Number | Peak | Stress | Minimum | Maximum | Median | |
| Cleaning | of | Stress | StDev | Stress | Stress | Stress | B10 |
| Agent | Samples | (MPa) | (MPa) | (MPa) | (MPa) | (MPa) | value |
| 4% Parker | 20 | 146.94 | 21.50 | 96.42 | 177.03 | 150.13 | 120 |
| Control (none) | 20 | 160.30 | 4.22 | 151.29 | 167.60 | 159.28 | 144 |
| Dry ice | 20 | 172.03 | 8.39 | 156.76 | 184.10 | 170.07 | 160 |
| Water | 20 | 150.44 | 14.37 | 121.07 | 171.93 | 151.60 | 132 |

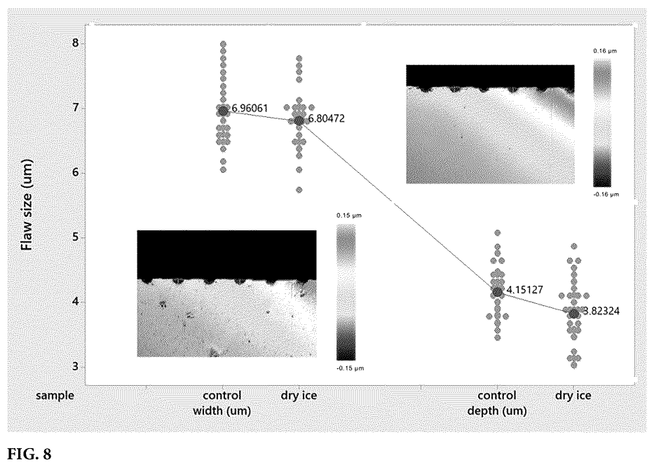

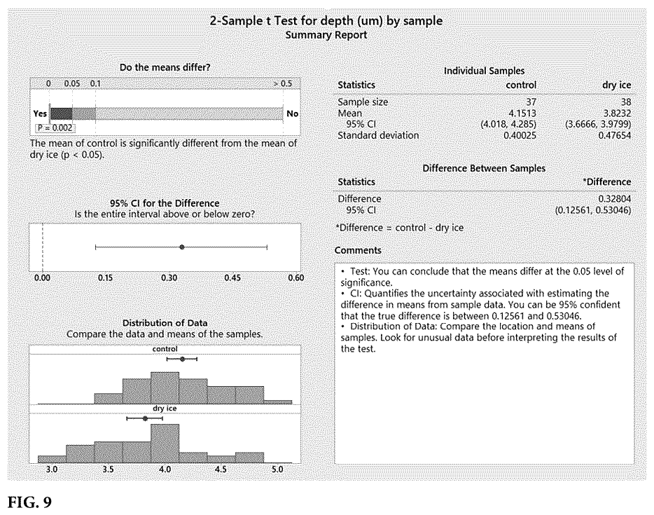

The flaw sizes of the samples were analyzed using the confocal microscope, through which no change in the flaw width was observed before and after the dry ice cleaning, while the flaw depth was reduced by 8% after the cleaning as shown in FIG. 8 and which was determined to be statistically different according to the 2-sample t test as shown in FIG. 9. The glass strength is heavily influenced by flaw depth and flaw curvature—the shallower the flaw, the stronger the glass. As a dry cleaning technology, when a stream of dry ice blasts across the glass surface, it quickly freezes the surface. The shrink of the glass surface generates light compression that helps to close very small surface flaws to some degree and reduce the flaw size. As a result, dry ice cleaning technology improves surface strength while also removing surface particles and not generating chemical wastes. It may be considered a green technology to clean and strengthen glass surface in one step.

### Exemplary Aspects

The following exemplary aspects are provided, the numbering of which is not to be construed as designating levels of importance:

Aspect 1 provides a method of cleaning a glass substrate, the method comprising:
contacting the glass substrate with a cleaning agent for a predetermined amount of time, wherein
the cleaning agent comprises a substance having a sublimation point in a range of from about −90° C. to about −70° C. and the cleaning agent is dispersed in a gas carrier.

Aspect 2 provides the method of Aspect 1, wherein the cleaning agent comprises a substance having a sublimation point in a range of from about −80° C. to about −70° C.

Aspect 3 provides the method of any one of Aspects 1 or 2, wherein the substance of the cleaning agent is carbon dioxide in a liquid or solid form.

Aspect 4 provides the method of any one of Aspects 1-3, wherein the gas carrier comprises a compressed gas.

Aspect 5 provides the method of any one of Aspects 1-4, wherein the gas carrier comprises compressed atmospheric air or a compressed nitrogen (N₂) gas.

Aspect 6 provides the method of any one of Aspects 4 or 5, wherein a pressure of the gas carrier is in a range of from about 1 Bar to about 7 Bar.

Aspect 7 provides the method of any one of Aspects 4-6, wherein a pressure of the gas carrier is in a range of from about 1.25 Bar to about 5.5 Bar.

Aspect 8 provides the method of any one of Aspects 1-7, wherein contacting the glass substrate comprises dispensing the cleaning agent from a dispensing apparatus.

Aspect 9 provides the method of Aspect 8, wherein the dispensing apparatus comprises a nozzle.

Aspect 10 provides the method of any one of Aspects 8 or 9, wherein the cleaning agent is dispensed at a rate in a range of from about 0.10 kg/min. to about 0.70 kg/min.

Aspect 11 provides the method of any one of Aspects 8-10, wherein the cleaning agent is dispensed at a rate in a range of from about 0.15 kg/min. to about 0.50 kg/min.

Aspect 12 provides the method of any one of Aspects 8-11, wherein the cleaning agent is dispensed at a variable rate.

Aspect 13 provides the method of any one of Aspects 8-12, wherein a distal end of the dispensing apparatus is located at a distance from the glass substrate in a range of from about 12.7 mm to about 152.4 mm.

Aspect 14 provides the method of any one of Aspects 8-13, wherein a distal end of the dispensing apparatus is located at a distance from the glass substrate in a range of from about 25.4 mm to about 76.2 mm.

Aspect 15 provides the method of any one of Aspects 13 or 14, wherein a distance between the distal end of the dispensing apparatus and the glass substrate is variable.

Aspect 16 provides the method of any one of Aspects 8-15, wherein the glass substrate is passed by the dispensing apparatus at a rate in a range of from about 3 mm/sec. to about 10 mm/sec.

Aspect 17 provides the method of any one of Aspects 8-16, wherein the glass substrate is passed by the dispensing apparatus at a rate in a range of from about 5 mm/sec. to about 8 mm/sec.

Aspect 18 provides the method of any one of Aspects 8-17, wherein the glass substrate is passed by the dispensing apparatus at a variable rate.

Aspect 19 provides the method of any one of Aspects 1-18, wherein the cleaning agent comprises one or more particles having a particle size in a range of from about 100 μm to about 1 mm in diameter.

Aspect 20 provides the method of any one of Aspects 1-19, wherein the cleaning agent comprises one or more particles having a particle size in a range of from about 1 μm to about 100 μm in diameter.

Aspect 21 provides the method of any one of Aspects 1-20, wherein the cleaning agent is contacted with an edge of the glass substrate.

Aspect 22 provides the method of any one of Aspects 1-21, wherein the glass substrate comprises: SiO₂ (50 to 70 mol %), Al₂O₃ (12 to 22 mol %), B₂O₃ (0 to 19 mol %), a mixture of: MgO, CaO, SrO, and BaO (0 to 15 mol %), MgO (0 to 15 mol %), BaO (0 to 2 mol %), ZnO (0 to 22 mol %), ZrO₂ (0 to 6 mol %), TiO₂ (0-8 mol %), and SnO₂ (0.01-0.1 mol %).

The terms and expressions that have been employed are used as terms of description and not of limitation, and there is no intention in the use of such terms and expressions of excluding any equivalents of the features shown and described or portions thereof, but it is recognized that various modifications are possible within the scope of the aspects of the present invention. Thus, it should be understood that although the present invention has been specifically disclosed by specific aspects and optional features, modification and variation of the concepts herein disclosed may be resorted to by those of ordinary skill in the art, and that such modifications and variations are considered to be within the scope of aspects of the present invention.

What is claimed is:

1. A method of cleaning a glass substrate, the method comprising:
contacting the glass substrate with a cleaning agent for a predetermined amount of time, wherein
the cleaning agent comprises a substance having a sublimation point in a range of from −90° C. to −70° C. and the cleaning agent is dispersed in a gas carrier.

2. The method of claim 1, wherein the cleaning agent comprises a substance having a sublimation point in a range of from −80° C. to −70° C.

3. The method of claim 1, wherein the substance of the cleaning agent is carbon dioxide in a liquid or solid form.

4. The method of claim 1, wherein the gas carrier comprises a compressed gas.

5. The method of claim 1, wherein the gas carrier comprises compressed atmospheric air or a compressed nitrogen (N₂) gas.

6. The method of claim 4, wherein a pressure of the gas carrier is in a range of from 1 Bar to 7 Bar.

7. The method of claim 4, wherein a pressure of the gas carrier is in a range of from 1.25 Bar to 5.5 Bar.

8. The method of claim 1, wherein contacting the glass substrate comprises dispensing the cleaning agent from a dispensing apparatus.

9. The method of claim 8, wherein the dispensing apparatus comprises a nozzle.

10. The method of claim 8, wherein the cleaning agent is dispensed at a rate in a range of from 0.10 kg/min. to 0.70 kg/min.

11. The method of claim 8, wherein the cleaning agent is dispensed at a rate in a range of from 0.15 kg/min. to 0.50 kg/min.

12. The method of claim 8, wherein a distal end of the dispensing apparatus is located at a distance from the glass substrate in a range of from 12.7 mm to 152.4 mm.

13. The method of claim 8, wherein a distal end of the dispensing apparatus is located at a distance from the glass substrate in a range of from 25.4 mm to 76.2 mm.

14. The method of claim 8, wherein the glass substrate is passed by the dispensing apparatus at a rate in a range of from 3 mm/sec. to 10 mm/sec.

15. The method of claim 8, wherein the glass substrate is passed by the dispensing apparatus at a rate in a range of from 5 mm/sec. to 8 mm/sec.

16. The method of claim 8, wherein the glass substrate is passed by the dispensing apparatus at a variable rate.

17. The method of claim 1, wherein the cleaning agent comprises one or more particles having a particle size in a range of from 100 μm to 1 mm in diameter.

18. The method of claim 1, wherein the cleaning agent comprises one or more particles having a particle size in a range of from 1 μm to 100 μm in diameter.

19. The method of claim 1, wherein the cleaning agent is contacted with an edge of the glass substrate.

20. The method of claim 1, wherein the glass substrate comprises:
50 to 70 mol % SiO₂,
12 to 22 mol % Al₂O₃,
0 to 19 mol % B₂O₃,
0 to 15 mol % MgO+CaO+SrO+BaO,
0 to 15 mol % MgO,
0 to 2 mol % BaO,
0 to 22 mol % ZnO,
0 to 6 mol % ZrO₂,
0-8 mol % TiO₂, and
0.01-0.1 mol % SnO₂.
